(19) United States
(12) Patent Application Publication
(10) Pub. No.: US 2025/0046279 A1
(43) Pub. Date: Feb. 6, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventors: MASAHIRO YOSHIDA, TOKYO (JP); KEI TATENO, TOKYO (JP)

(21) Appl. No.: 18/718,190

(22) PCT Filed: Nov. 1, 2022
(86) PCT No.: PCT/JP2022/040893

§ 371 Date: Jun. 10, 2024

(30) Foreign Application Priority Data
Dec. 17, 2021 (JP) 2021-204740

(51) Int. Cl. G10H 1/00

(52) U.S. Cl. CPC G10H 1/0025

(57) ABSTRACT

To realize generation of lyrics with a wide variety of harmonizing melodies. Provided is an information processing device including: a sound information series generation unit that generates a sound information series harmonized with an input melody by using a learned model; and a lyrics generation unit that generates lyrics harmonized with the melody on the basis of the melody and the sound information series by using the learned model, in which the sound information series includes at least a series of a vowel sound or the like harmonized with the melody.

### TECHNICAL FIELD

The present disclosure relates to an information processing device, an information processing method, and a program.

### BACKGROUND ART

In recent years, various music including lyrics have been provided. In addition, for example, as disclosed in Patent Document 1, a technique for automatically generating lyrics to be added to a melody has also been developed.

### CITATION LIST

### Patent Document

Patent Document 1: Japanese Patent Application Laid-Open No. 2017-156495

### SUMMARY OF THE INVENTION

### Problems to be Solved by the Invention

However, a technique disclosed in Patent Document 1 merely applies fragments of existing lyrics to an input melody, and it is difficult to say that the technique is sufficient for harmonizing the melody.

### Solutions to Problems

According to one aspect of the present disclosure, there is provided an information processing device, including: a sound information series generation unit that generates a sound information series harmonized with an input melody by using a learned model; and a lyrics generation unit that generates lyrics harmonizing with the melody on the basis of the melody and the sound information series by using the learned model, in which the sound information series includes at least a vowel sound series harmonized with the melody.

Furthermore, according to another aspect of the present disclosure, there is provided an information processing method including: by a processor, generating a sound information series harmonized with an input melody by using a learned model; and generating, by using the learned model, lyrics harmonized with the melody on the basis of the melody and the sound information series, in which the sound information series includes at least a vowel sound series harmonized with the melody.

Furthermore, according to another aspect of the present disclosure, there is provided a program for causing a computer to function as an information processing device, the information processing device including: a sound information series generation unit that generates a sound information series harmonized with an input melody by using a learned model; and a lyrics generation unit that generates lyrics harmonized with the melody on the basis of the melody and the sound information series by using the learned model, in which the sound information series includes at least a vowel sound series harmonized with the melody.

### BRIEF DESCRIPTION OF DRAWINGS

FIG. 1 is a block diagram illustrating a configuration example of an information processing device 10 according to an embodiment of the present disclosure.

FIG. 2 is a flowchart illustrating an example of an overall flow of processing executed by the information processing device 10 according to the embodiment.

FIG. 3 is a diagram illustrating lyrics generation according to the embodiment.

FIG. 4 is a diagram illustrating an example of a learned model used for Japanese lyrics generation according to the embodiment.

FIG. 5 is a diagram illustrating an example of a learned model used for English lyrics generation according to the embodiment.

FIG. 6 is a diagram illustrating an exemplary structure of metadata and the like input to an NNLM 155 according to the embodiment.

FIG. 7 is a flowchart illustrating an example of a flow of free input correction by a user according to the embodiment.

FIG. 8 is a flowchart illustrating an example of a flow of correction based on an alternative candidate according to the embodiment.

FIG. 9 is a diagram illustrating an example of an initial screen of a user interface controlled by a user interface control unit 160 according to the embodiment.

FIG. 10 is a diagram illustrating an example of a user interface after reading melody information according to the embodiment.

FIG. 11 is a diagram illustrating an example of a user interface related to condition input of Japanese lyrics generation according to the embodiment.

FIG. 12 is a diagram illustrating an example of a user interface after generation of Japanese lyrics according to the embodiment.

FIG. 13 is a diagram illustrating an example of a user interface related to selection of a correction portion of Japanese lyrics according to the embodiment.

FIG. 14 is a diagram illustrating an example of a user interface related to alternative candidate presentation of Japanese lyrics according to the embodiment.

FIG. 15 is a diagram illustrating a user interface example related to condition input of English lyrics generation according to the embodiment.

FIG. 16 is a diagram illustrating an example of a user interface after generation of English lyrics according to the embodiment.

FIG. 17 is a diagram illustrating an example of a user interface related to selection of a correction portion of English lyrics according to the embodiment.

FIG. 18 is a diagram illustrating an example of a user interface related to alternative candidate presentation of Japanese lyrics according to the embodiment.

FIG. 19 is a block diagram illustrating a hardware configuration example of an information processing device 90 according to the embodiment.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configurations are denoted by the same reference signs, and redundant explanations will be omitted.

Note that the description will be given in the following order.
1. Embodiment
1.1. Outline
1.2. Exemplary configuration of information processing device 10
1.3. Processing details
1.4. User interface example
2. Exemplary hardware configuration
3. Conclusion

### 1. Embodiment

### <<1.1. Overview>>

First, an overview of an embodiment of the present disclosure will be described.

As described above, in recent years, a technique for automatically generating lyrics according to an input melody has been proposed.

For example, according to the technique disclosed in Patent Document 1, it is possible to cut the cost of manual lyrics and to easily obtain lyrics even by a user who does not have a technique or knowledge related to the lyrics.

However, it is difficult to generate better lyrics only by arranging phrases according to a length of the melody or the like.

For example, it is difficult to say that the technique disclosed in Patent Document 1 is sufficiently considered in the model from the viewpoint of harmony with a melody.

Further, in the technique disclosed in Patent Document 1, a fragment of existing lyrics is applied to a melody, but in such a technique, variations of the generated lyrics are limited, and thus it is difficult to say that the technique is practical as a technique for supporting production of practically used lyrics.

A technical idea according to an embodiment of the present disclosure has been conceived by focusing on the above points, and realizes generation of lyrics with a wide variety of harmonizing melodies.

In order to achieve the above, the information processing device 10 according to an embodiment of the present disclosure automatically generates lyrics using a sound information series generation model and a lyrics generation model generated using a machine learning technology.

Here, sound information according to an embodiment of the present disclosure will be defined. The sound information according to an embodiment of the present disclosure refers to information necessary for reading out a certain word.

More specifically, the sound information series according to an embodiment of the present disclosure may include a number of syllables, a vowel sound series, and an accent series.

First, sound information in Japanese will be described with specific examples.

First, the number of syllables will be described. For example, in the case of the word “yuuenchi (amusement park)” in Japanese, the number of syllables is five of “yu-u-e-n-chi”.

Next, vowel sound series will be described. In the case of Japanese, it is assumed that the vowel sound of the lyrics critically affects the harmony to the melody.

For this reason, information regarding the five types and the number of vowels of the Japanese vowel sound series “a, e, i, o, u” according to the embodiment of the present disclosure may be included.

In addition, in addition to vowel sound, a syllabic nasal “n”, a double consonant “tsu”, a long sound “-”, and the like also strongly affect the harmony to the melody. Therefore, the vowel sound series in Japanese according to an embodiment of the present cancellation may include “n”, “_”, and “-” corresponding to the syllabic nasal, the double consonant, and the long sound, respectively.

For example, in the case of the word “yuuenchi (amusement park)”, the vowel sound series is represented as “u-u-e-n-i”. In addition, in the case of the word “match”, the vowel sound series is represented as “a-_- i”. Furthermore, in the case of the word “team”, the vowel sound series is represented as “i - - - u”.

Next, the accent series will be described. Since Japanese is a high-low accent, in the Japanese sound information series according to an embodiment of the present disclosure, a portion with a high accent sound is represented by “H”, and a portion with a low accent sound is represented by “L”.

For example, in the case of the word “yuuenchi (amusement park)”, the accent series is represented as “LHHLL”.

The sound information series in Japanese according to the embodiment of the present disclosure has been described above with specific examples. Next, a sound information series in English according to an embodiment of the present disclosure will be described.

First, the number of syllables will be described. For example, in the case of the word “important”, the number of syllables is 3 for “im-por-tant”.

Next, vowel sound series will be described. In the case of English, it is assumed that consonants in addition to vowels greatly affect the harmony to the melody.

In view of the above, the vowel sound series in English according to an embodiment of the present disclosure includes vowels in phonetic symbols and consonant sound types.

Examples of the consonant type include “close-tone”, “frictional”, “side sound”, and “half vowel”.

As an example, in the case where the nasal sound (m, n, etc.) is <m>and the closing sound (p, t, etc.) is <p>, the word “important” (Im-′po:.-tent) can be expressed as “I<m>-′<p> [symbol] :.-<p> [symbol] <m><p>” in the vowel sound series.

Next, the accent series will be described. Since English is a strong and weak accent, in the English sound information series according to an embodiment of the present disclosure, a portion with a strong accent is represented by “H”, and other portions are represented by “L”.

For example, since there is an accent in the middle of the word “important”, the accent series is represented as “LHL”.

The definition of the vowel sound series according to the embodiment of the present disclosure has been described above. Hereinafter, a configuration example of the information processing device 10 that generates lyrics based on the vowel sound sequence will be described.

### <<1.2. Configuration Example of Information Processing Device 10>>

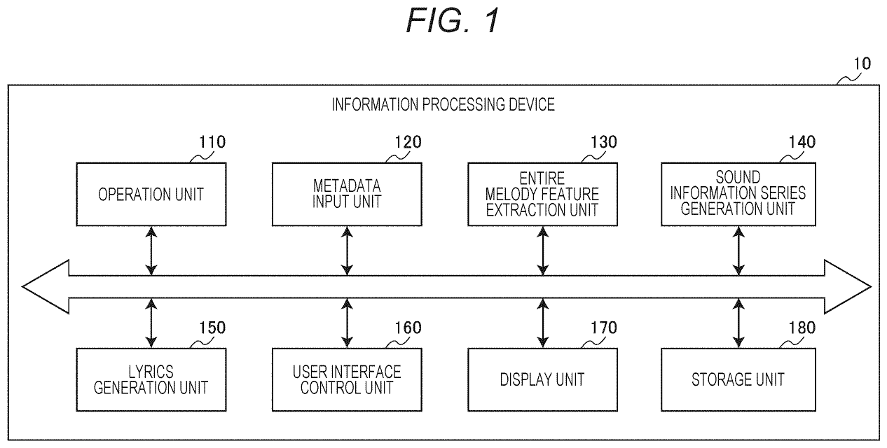

FIG. 1 is a block diagram illustrating a configuration example of an information processing device 10 according to an embodiment of the present disclosure.

As illustrated in FIG. 1, the information processing device 10 according to the present embodiment may include an operation unit 110, a metadata input unit 120, an entire melody feature extraction unit 130, a sound information series generation unit 140, a lyrics generation unit 150, a user interface control unit 160, a display unit 170, and a storage unit 180.

### (Operation Unit 110)

The operation unit 110 according to the present embodiment receives an operation by a user. For this purpose, the operation unit 110 according to the present embodiment includes a keyboard, a mouse, and the like.

### (Metadata Input Unit 120)

The metadata input unit 120 according to the present embodiment inputs the input information received by the operation unit 110 and various types of information stored in the storage unit 180 to the lyrics generation unit 150 as metadata.

A specific example of the metadata according to the present embodiment will be described later.

(Entire Melody Feature Extraction unit 130)

The entire melody feature extraction unit 130 according to the present embodiment extracts features (latent expressions) of the entire music with a melody as an input.

The latent expression extracted by the entire melody feature extraction unit 130 is input to the lyrics generation unit 150. As a result, the lyrics generation unit 150 can generate the lyrics with high accuracy in consideration of the tune.

### (Sound Information Series Generation Unit 140)

The sound information series generation unit 140 according to the present embodiment generates a sound information series harmonized with an input melody by using the learned model.

The function of the sound information series generation unit 140 according to the present embodiment is realized by various processors. The function of the sound information series generation unit 140 according to the present embodiment will be separately described in detail.

### (Lyrics Generation Unit 150)

The lyrics generation unit 150 according to the present embodiment generates lyrics harmonized with an input melody on the basis of the melody and the sound information series by using the learned model.

The function of the lyrics generation unit 150 according to the present embodiment is realized by various processors. The function of the lyrics generation unit 150 according to the present embodiment will be separately described in detail.

### (User Interface Control Unit 160)

The user interface control unit 160 according to the present embodiment receives designation of a melody by the user, and controls the user interface that presents the lyrics generated by the lyrics generation unit 150.

The functions of the user interface control unit 160 according to the present embodiment are implemented by various processors. An example of the user interface according to the present embodiment will be separately described.

### (Display Unit 170)

The display unit 170 according to the present embodiment displays various types of information under the control of the user interface control unit 160. For this purpose, the display unit 170 according to the present embodiment includes a display.

### (Storage Unit 180)

The storage unit 180 according to the present embodiment stores information and the like used by each component included in the information processing device 10.

Examples of the information stored in the storage unit 180 according to the present embodiment include metadata, melodies (music), a sound information series, and lyrics generated by the lyrics generation unit 150.

The configuration example of the information processing device 10 according to the present embodiment has been described above. Note that, the configuration described above with reference to FIG. 1 is merely an example, and the configuration of the information processing device 10 according to the present embodiment is not limited to such an example.

For example, each configuration described above may be implemented by being distributed to a plurality of devices. As an example, the operation unit 110 and the display unit 170 may be mounted on a locally arranged device, and other configurations may be mounted on a server arranged in a cloud.

The configuration of the information processing device 10 according to the present embodiment can be flexibly modified in accordance with specifications and operations.

### <<1.3. Details of Processing>>

Next, processing executed by the information processing device 10 according to the present embodiment will be described in detail.

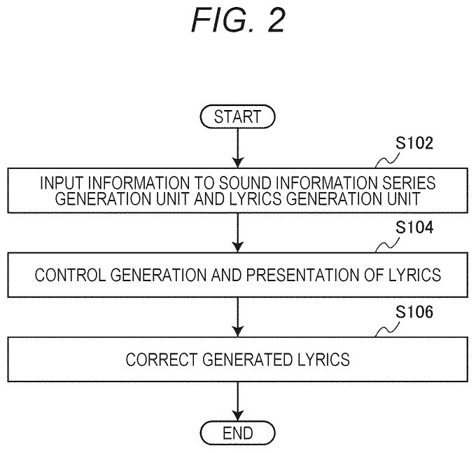

FIG. 2 is a flowchart illustrating an example of an overall flow of processing executed by the information processing device 10 according to the present embodiment.

First, information is input to the sound information series generation unit 140 and the lyrics generation unit 150 (S102).

Examples of the information input in step S102 include melodies, metadata, and restriction information regarding lyrics expression.

Next, lyrics are generated and the generated lyrics are presented on the basis of the information input in step S102 (S104).

In step S104, the lyrics generation unit 150 generates lyrics on the basis of the input melody, metadata, restriction information related to the lyrics expression, the sound information series generated by the sound information series generation unit 140, and the like.

Furthermore, in step S104, the user interface control unit 160 controls the lyrics generated by the lyrics generation unit 150 to be presented on the user interface.

Next, the generated lyrics are corrected on the basis of the user operation (S106). The correction of the lyrics according to the present embodiment will be separately described in detail.

An example of the overall flow of processing executed by the information processing device 10 according to the present embodiment has been described above.

### (Generation of Lyrics)

Next, information input in step S102 and generation of lyrics in step S104 will be described in detail.

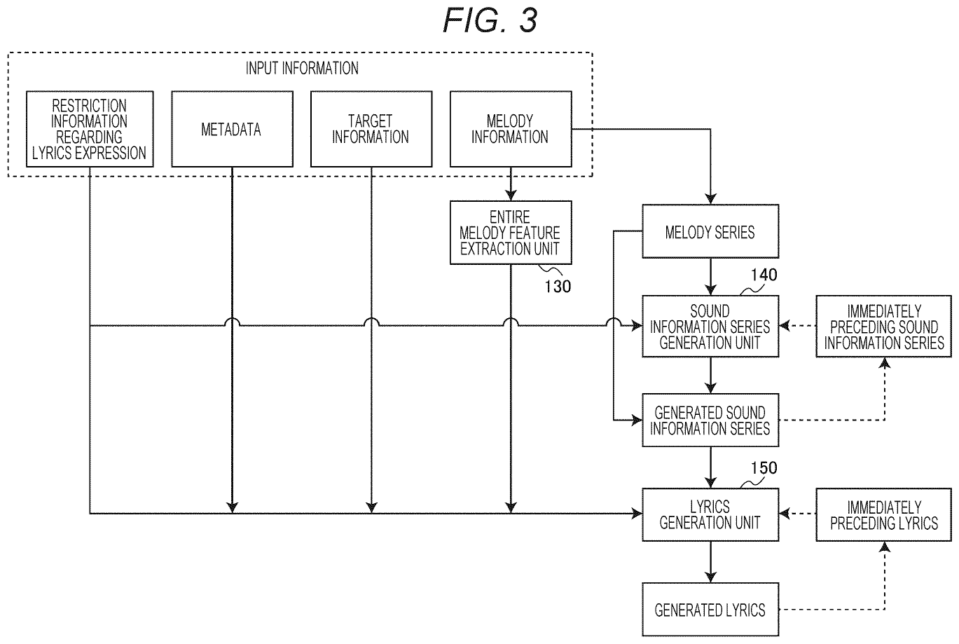

FIG. 3 is a diagram illustrating lyrics generation according to the present embodiment.

FIG. 3 illustrates an example of information input to the sound information series generation unit 140 and the lyrics generation unit 150.

As illustrated in FIG. 3, melody information is input to the sound information series generation unit 140 and the lyrics generation unit 150 according to the present embodiment. The user may be able to specify a sound source including melody information, such as MIDI, other audio files, or symbolic data such as musical scores, in the user interface.

Furthermore, the melody information according to the present embodiment may include information regarding a music composition (for example, Intro, Verse, Bridge, Chorus, Outro, etc.).

Note that the input of the melody information to the sound information series generation unit 140 and the lyrics generation unit 150 may be performed, for example, in the case of Japanese, in units of length corresponding to the lyrics of about 10 to 20 characters (the length of the lyrics from the breathing to the next breathing), and the lyrics may be generated for each unit.

In this case, in a case where the lyrics of the entire music are generated, the sound information series generation and the lyrics generation are recursively executed. A line segment indicated by a dotted line in FIG. 3 indicates that the immediately preceding sequence is a sequence generated at a previous time in a case where recursive processing is performed.

Note that it is also possible to generate the lyrics of the entire music at a time without performing the recursive processing as described above, but it is possible to save calculation resources in the case of performing the recursive processing.

As illustrated in FIG. 3, the sound information series generation unit 140 according to the present embodiment receives the melody information and the immediately preceding sound information series, and generates a natural sound information series that is in harmony with the melody series by using the learned model. However, it is not always necessary to input the immediately preceding sound information series.

Furthermore, as described above, the sound information series according to the present embodiment may include the number of syllables, a series such as vowels, an accent series, and the like.

However, the sound information series generation unit 140 does not necessarily need to generate the number of syllables and the accent series. Even in this case, the lyrics generation unit 150 can generate the lyrics on the basis of the vowel sound series.

Furthermore, the sound information series generation unit 140 according to the present embodiment can also generate a sound information series corresponding to a non-designated portion so that the user does not feel uncomfortable in connection between the designated portion and the non-designated portion on the basis of the designation of the sound information series by the user. The function will be separately described in detail.

On the other hand, in addition to the melody information and the sound information series, various types of information specified by the user are input to the lyrics generation unit 150 according to the present embodiment.

The various types of information specified by the user include constraint information related to lyrics expression, various types of metadata, and information (target information) related to a target of the generated lyrics.

The constraint information related to the lyrics expression according to the present embodiment includes, for example, some lyrics specified by the user. For example, in a case where the lyrics are determined only at the beginning of the chorus, the user can specify the lyrics by using the user interface, and cause the lyrics generation unit 150 to automatically generate the lyrics other than the specified part.

In this case, the lyrics generation unit 150 generates the lyrics harmonized with the melody other than the part where the lyrics are specified so as to be consistent with the specified lyrics.

Furthermore, the constraint information related to the lyrics expression according to the present embodiment may include, for example, vowels and accents of some phrase specified by the user. The user may be able to use the user interface to, for example, designate the vowel at the opening of the chorus to “a”.

Furthermore, the constraint information related to the lyrics expression according to the present embodiment may include, for example, a phrase desired to be included and a phrase not desired to be included.

In a case where there is a phrase that the user always wants to include even if the place is not determined, the user may be able to specify the phrase using the user interface. In this case, the lyrics generation unit 150 generates the lyrics so that the specified phrase is included somewhere in the lyrics.

On the other hand, in a case where a phrase that is not desired to be included is specified, the lyrics generation unit 150 generates lyrics so as not to include the specified phrase.

The specific examples of the constraint information related to the lyrics expression according to the present embodiment have been described above. The lyrics generation unit 150 according to the present embodiment may generate lyrics harmonized with a melody on the basis of the constraint information related to the lyrics expression as described above.

According to the above, it is possible to generate the lyrics with high accuracy in compliance with the constraint designated by the user.

Next, metadata according to the present embodiment will be described with specific examples. The lyrics generation unit 150 according to the present embodiment may generate lyrics harmonized with a melody on the basis of metadata specified by the user.

The metadata according to the present embodiment may be, for example, various types of additional information related to a melody or generated lyrics. The metadata according to the present embodiment may include, for example, additional information regarding an artist who sings the generated lyrics and an artist who composes a melody.

Examples of the additional information regarding the artist include a name, an age, a gender, a past work, and a background of the artist.

Note that the metadata input unit 120 may acquire the above-described additional information from the storage unit 180 using the artist name input by the user using the operation unit 110 as a key, and input the additional information to the lyrics generation unit 150.

Meanwhile, the additional information regarding the artist as described above may be directly input by the user.

Furthermore, the metadata according to the present embodiment may include additional information regarding a genre or a theme of music.

Examples of the genre include rock, pops, ballad, fork, and lap.

Furthermore, the themes may be, for example, various themes determined among users such as a love song, a love song, a main character being a male, and a main character being a female.

The user may select any theme from the presets by using the user interface. In this case, it is desirable to prepare a phrase (for example, a broken heart, a friendship, a dream, a world, or the like) that is likely to be adopted as a theme of lyrics in the preset.

On the other hand, the user may freely input a theme with a word or a sentence using the user interface. For example, the user may be able to specify the theme by a combination of a plurality of words such as “high school student +divination +sea”, or the like, or may be able to specify the theme by a sentence such as “high school student in unrequited love decides to tell his/her love while looking at the sea”.

The specific examples of the metadata according to the present embodiment have been described above. With use of the metadata as described above, it is possible to generate the lyrics more suitable for music with high accuracy.

Next, the target information according to the present embodiment will be described with reference to specific examples of metadata. The lyrics generation unit 150 according to the present embodiment may generate lyrics harmonized with a melody on the basis of information related to a target of the generated lyrics.

The target information according to the present embodiment may include, for example, graphical metadata such as age, sex, family structure, distinction between married and unmarried, and hometown of the target customer.

Furthermore, the target information according to the present embodiment may include, for example, information such as music that the target customer is expected to preferably listen to, music played/purchased by the target customer in the past in a streaming service or the like.

With use of the target information as described above, it is possible to generate the lyrics with high appeal to the target customer with high accuracy.

Furthermore, the lyrics generation unit 150 according to the present embodiment may generate lyrics harmonized with a melody further on the basis of the feature (latent expression) of the entire music including the melody extracted by the entire melody feature extraction unit 130.

According to the above, it is possible to generate the lyrics with higher accuracy in consideration of the tune.

In addition, the lyrics generation unit 150 according to the present embodiment may generate lyrics harmonized with a melody on the basis of the previous lyrics.

According to the above, the lyrics can be generated in further consideration of the sound information corresponding to the immediately preceding lyrics, and the lyrics can be generated with higher harmonicity.

The lyrics generation according to the present embodiment has been described above with reference to specific examples of input information. However, it is not always necessary to input all the information listed above. The user may additionally input information as necessary, and in the case where the information is input, the lyrics generation unit 150 may generate lyrics on the basis of the information.

Next, the learned model according to the present embodiment will be described with a specific example.

As described above, the learned model is used for the sound information series generation and the lyrics generation according to the present embodiment.

The learned model according to the present embodiment may be, for example, a model based on an autoregressive (Autoregressive, AR) neural network language model (NNLM) represented by a GPT-3.

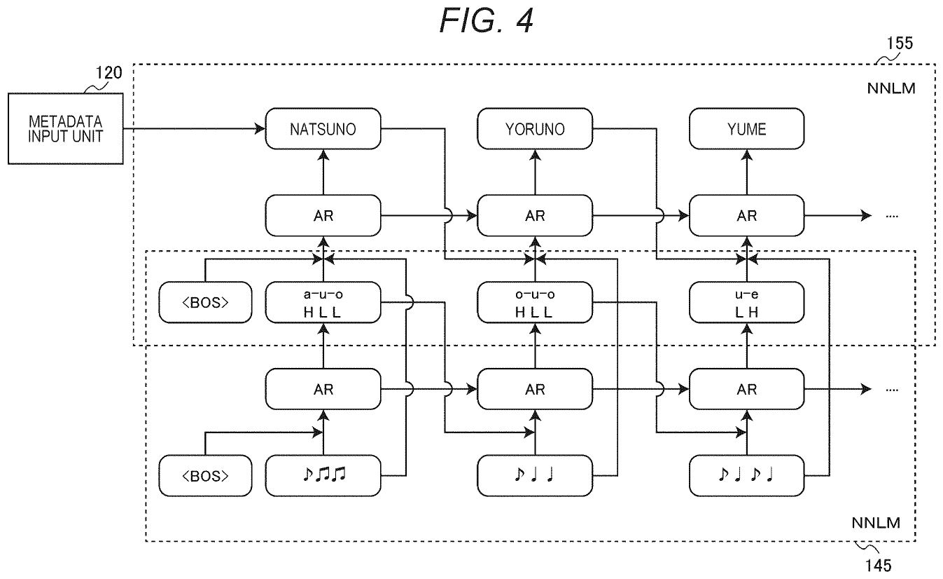

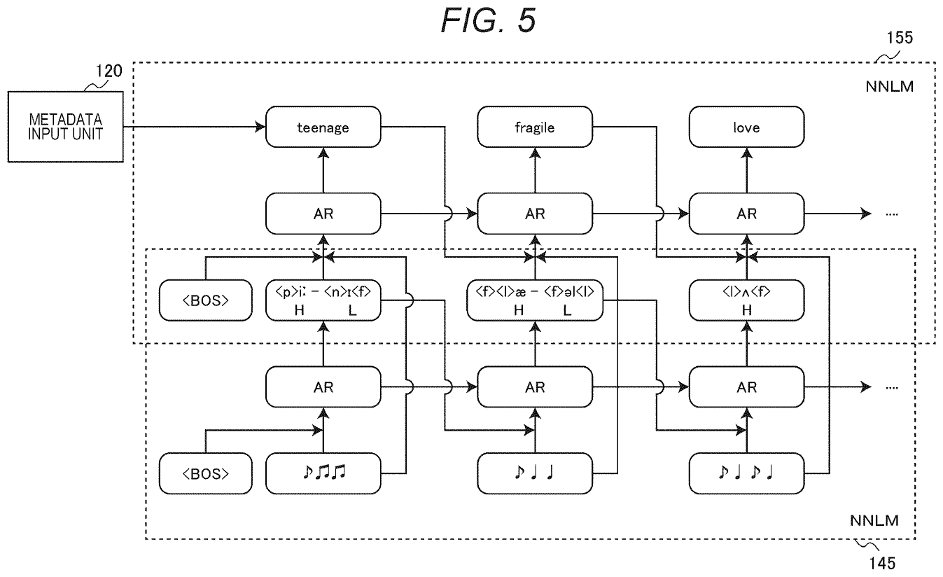

FIG. 4 is a diagram illustrating an example of a learned model used for generating Japanese lyrics according to the present embodiment. Furthermore, FIG. 5 is a diagram illustrating an example of a learned model used for English lyrics generation according to the present embodiment.

In the examples illustrated in FIGS. 4 and 5, an NNLM 145 and an NNLM 155 are used in the sound information series generation (prediction of the sound information series) by the sound information series generation unit 140 and the lyrics generation (prediction of the lyrics) by the lyrics generation unit 150, respectively.

The NNLM 145 receives a melody series of the current time as an input together with a sound information series (vowel sound series, accent series, and the like) before 1:00, and predicts a vowel sound series and an accent series of the next time.

On the other hand, the NNLM 155 predicts the lyrics of the next time using the lyrics before 1:00 and the sound information series of the current time as inputs. Furthermore, the latent expression of the entire melody and the metadata are input to the NNLM 155 at the time before the prediction of the lyrics starts.

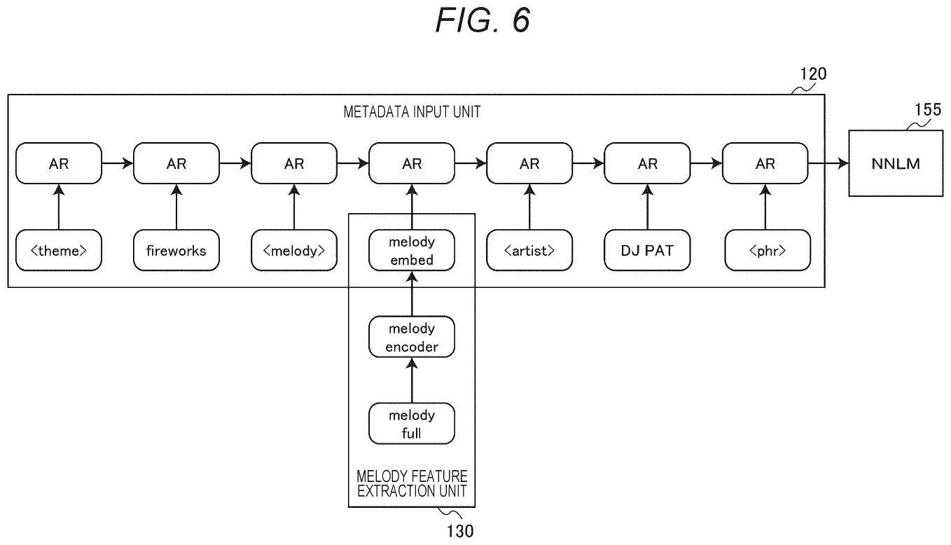

FIG. 6 is a diagram illustrating an exemplary structure of metadata and the like input to the NNLM 155 according to the present embodiment.

The entire melody feature extraction unit 130 extracts a latent expression of the entire melody. As the Melody Encoder illustrated in the drawing, VQ-VAE, BERT, or the like may be adopted.

Furthermore, the metadata input unit 120 inputs various information such as artist information, a theme of a song, and target information to the NNLM 155.

There are various methods of inputting the metadata and the like to the NNLM 155, and as a further implementation method, there is a method of handling each piece of information as a series as illustrated in FIG. 6. Note that, in FIG. 6, only an artist name and a word to be a theme are input, but demographic information of a target layer and the like can also be input by a similar method.

The learned model according to the present embodiment has been described above by way of example. Note that a model in which a melody and lyrics are associated with each other is used as the learning data. It is desirable that the sound information is also associated with the learning data, but it is not essential since prediction can be performed from the lyrics (in the learning phase, the sound information is predicted in advance from the lyrics data.). The NNLM 145 and the NNLM 155 are only required to be trained at an end-2-end using the data as described above.

In addition, in a case where the entire lyrics are generated from the beginning, input is started to the NNLM 145 from the beginning of the melody, but in a case where an alternative candidate for a phrase is generated in the correction of the lyrics to be described later, the phrase of the relevant portion may be generated again by receiving melody information several bars before the specified portion and the lyrics.

### (Correction of Lyrics)

Next, the lyrics correction according to the present embodiment will be described in detail. As described above, the lyrics generation unit 150 according to the present embodiment can automatically generate lyrics harmonized with a melody on the basis of various information.

However, the user may not like all of the generated lyrics. Therefore, as illustrated in step S106 of FIG. 2, the information processing device 10 according to the present embodiment may execute various types of processing related to lyrics correction.

The lyrics correction according to the present embodiment is assumed to be free input correction by the user and correction based on an alternative candidate to be presented.

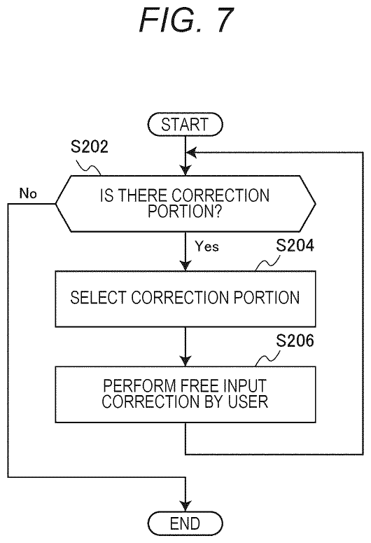

First, free input correction by the user according to the present embodiment will be described. FIG. 7 is a flowchart illustrating an example of a flow of free input correction by the user according to the present embodiment.

In free input correction, in a case where there is a correction portion (S202: Yes), the user selects the correction portion in the user interface (S204), and performs free input correction (S206).

On the other hand, in a case where there is no correction portion (S202: No), the user performs a confirmation operation or the like, and a series of processing related to correction ends.

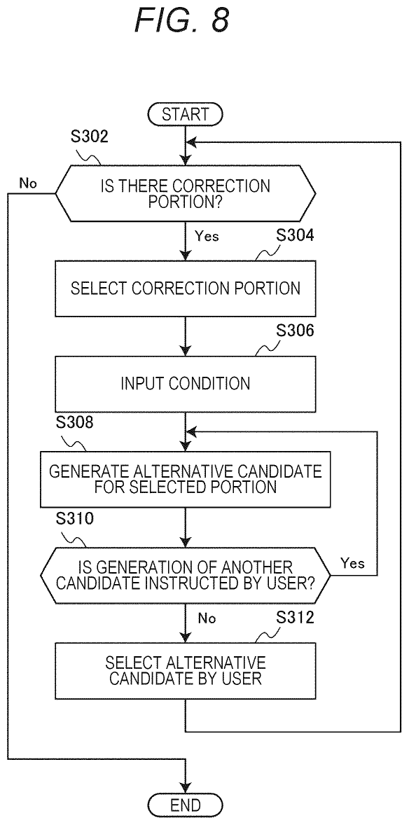

Next, correction based on the alternative candidate according to the present embodiment will be described. FIG. 8 is a flowchart illustrating an example of a flow of correction based on an alternative candidate according to the present embodiment.

In a case where there is a correction portion (S302: Yes), the user selects the correction portion in the user interface (S304).

In addition, the user inputs a condition related to alternative candidate generation as necessary (S306).

Examples of the above condition include designation of a sound information series of an alternative candidate to be generated.

The lyrics generation unit 150 generates an alternative candidate on the basis of the correction portion selected in step S304 and the condition input in step S306 (S308).

Here, in a case where further generation of another candidate is instructed by the user (S310: Yes), the lyrics generation unit 150 repeatedly executes generation of an alternative candidate in step S308.

On the other hand, the user does not issue an instruction to generate another candidate (S310: No) and the user selects an alternative candidate (S312), and then the process returns to S302.

In a case where there is no correction portion (S302: No), the user performs a confirmation operation or the like, and a series of processing related to correction ends.

The flow of correction based on the alternative candidate according to the present embodiment has been described with an example.

As described above, the lyrics generation unit 150 according to the present embodiment may generate an alternative candidate of a phrase selected by the user on the basis of the sound information series.

According to the generation of the alternative candidate according to the present embodiment, the user can select a phrase from more variations, and it is possible to effectively reduce the labor of correction.

### <<1.4. User Interface Example>>

Next, a user interface according to the present embodiment will be described with a specific example.

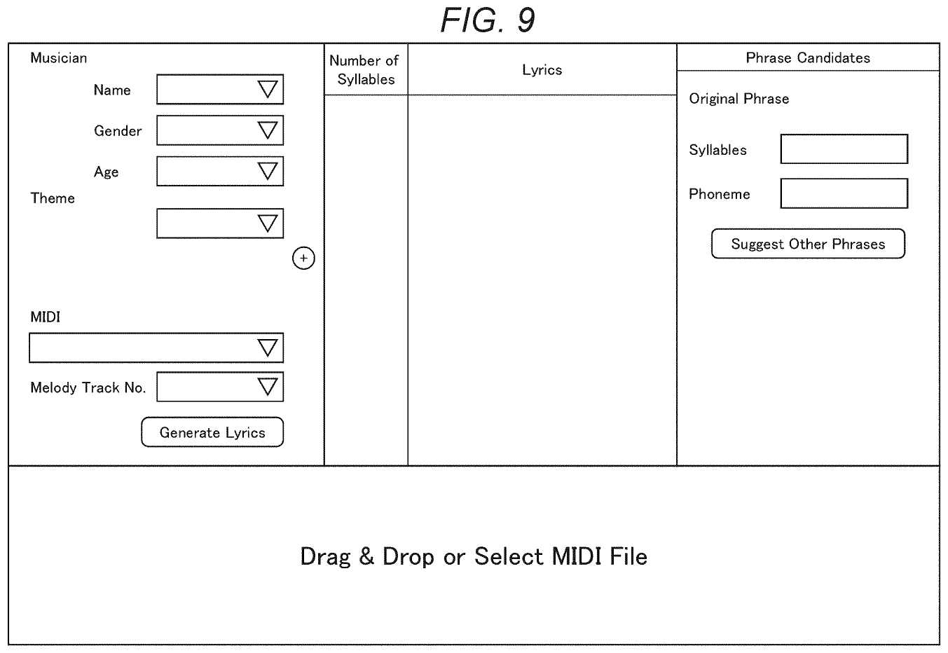

FIG. 9 is a diagram illustrating an example of an initial screen of a user interface controlled by the user interface control unit 160 according to the present embodiment.

In an upper-left pane of the user interface according to the present embodiment, fields for the user to specify metadata, melody information (for example, MIDI or the like), and the like are displayed.

Note that, although not illustrated in FIG. 9, a field for specifying constraint information, target information, and the like related to the lyrics expression may be displayed in the pane.

The user may select any item from the presets in each field or freely input information.

Furthermore, the generated lyrics, the number of syllables related to the lyrics, and the like are displayed in the pane at an upper center of the user interface according to the present embodiment.

In an initial screen illustrated in FIG. 9, since the lyrics have not been generated yet, information is not displayed in an upper-middle pane.

Furthermore, an upper-right pane of the user interface according to the present embodiment is a pane for performing input related to an alternative candidate. In a stage where the lyrics are not generated, the pane may be grayed out or the like in a state where the operation cannot be performed.

Furthermore, a lower pane of the user interface according to the present embodiment may be a pane that displays the read melody information in, for example, a piano roll format.

In an initial screen illustrated in FIG. 9, the melody information has not yet been designated. Therefore, in the lower pane, instead of presenting the melody information, the melody information may be designated in a drag-and-drop format.

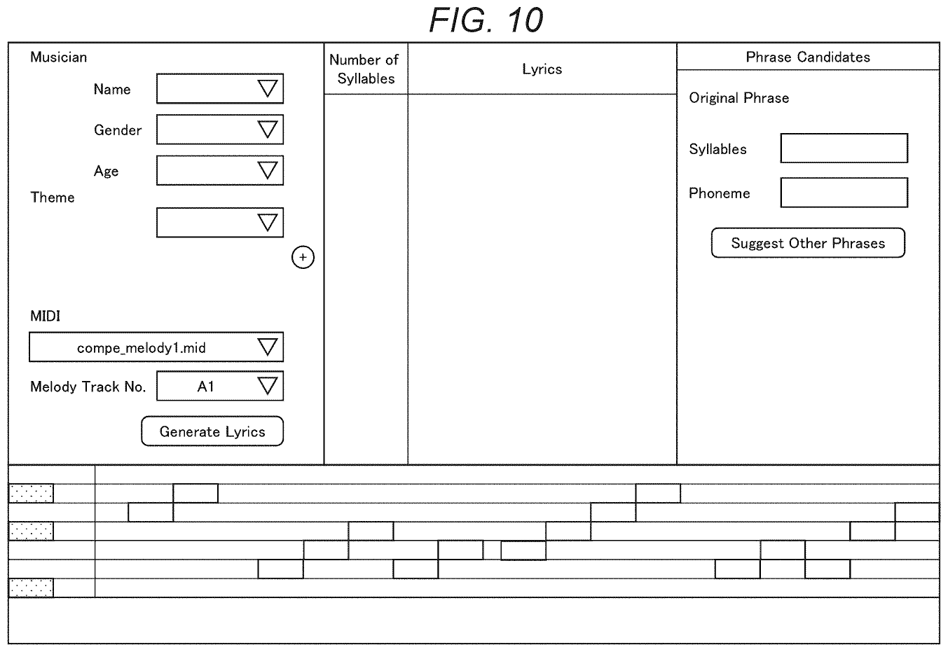

FIG. 10 is a diagram illustrating an example of a user interface after reading melody information according to the present embodiment.

The user designates the melody information (in the example illustrated in FIG. 10, the MIDI sound source and the melody track are designated) in the upper left pane, the melody information read in the lower pane is displayed in, for example, a piano roll format as illustrated in FIG. 10.

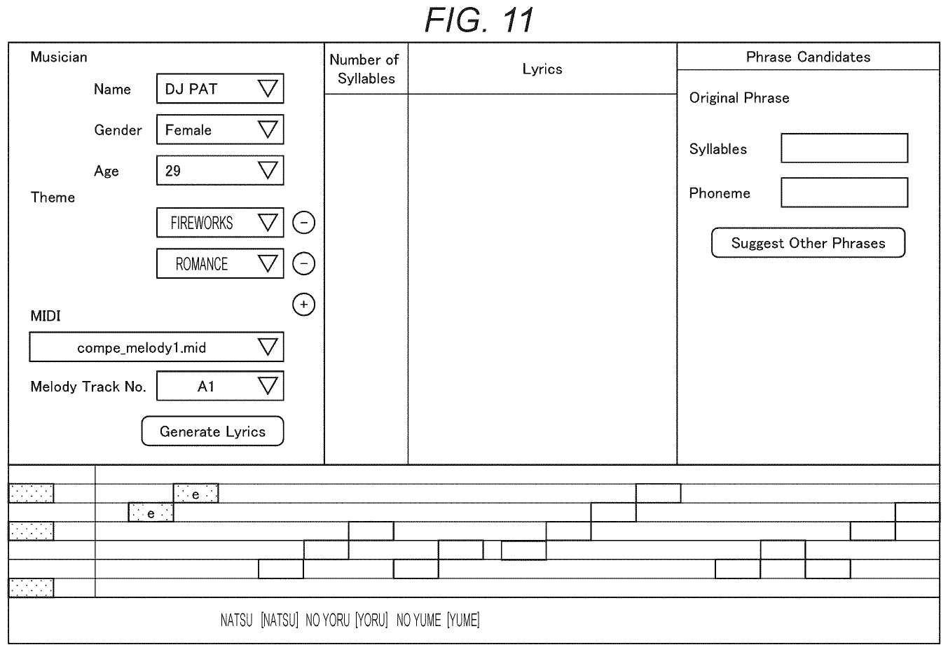

FIG. 11 is a diagram illustrating an example of a user interface related to condition input of Japanese lyrics generation according to the present embodiment.

In the example illustrated in FIG. 11, the user designates meta information in addition to melody information in the upper left pane. Note that the meta information, the restriction information regarding the lyrics expression, the target information, and the like may be specified before the melody information is read.

Furthermore, in the case of the example illustrated in FIG. 11, the user performs at the designation (“e” and “e”) of a sound information series (vowel sound series and the like) at the beginning portion, designates lyrics (“dreaming (yume in Japanese) of “summer [natsu] night [yoru]”) at the following portion in the lower pane.

The user specifies each condition as described above and further clicks the “Generate Lyrics” button in the upper left pane, and then lyrics generation by the lyrics generation unit 150 is executed.

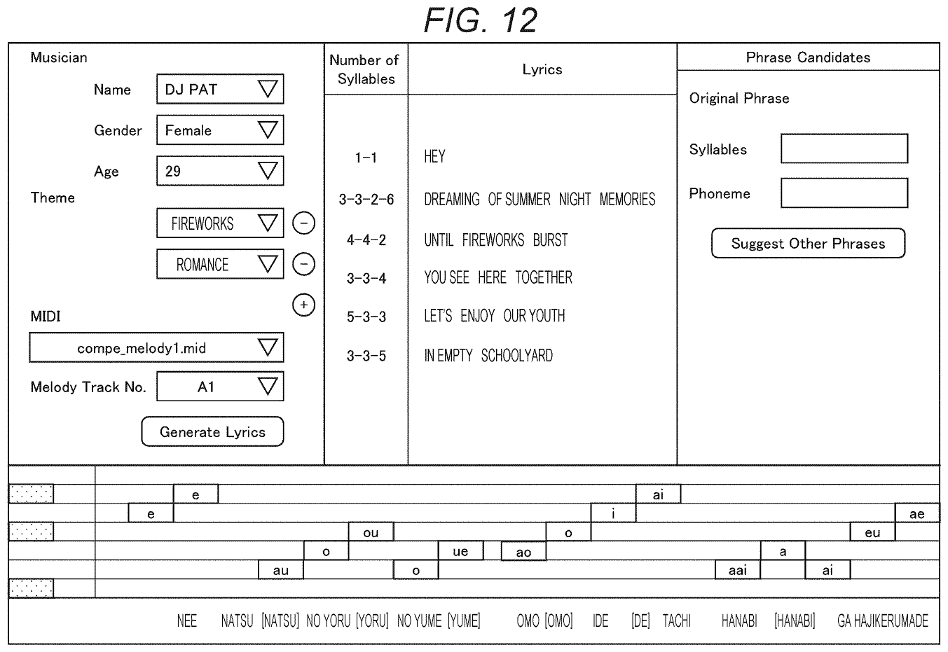

FIG. 12 is a diagram illustrating an example of a user interface after generation of Japanese lyrics according to the present embodiment.

An upper center pane in FIG. 12 displays the lyrics generated by the lyrics generation unit 150 on the basis of the input condition (metadata, sound information series, lyrics).

As illustrated in FIG. 12, the lyrics generation unit 150 according to the present embodiment can generate lyrics “Hey” harmonized with the melody on the basis of a sound information series (“e”, “e”) designated by the user.

Furthermore, as illustrated in FIGS. 11 and 12, the user interface according to the present embodiment may receive designation of a sound information series by the user and present lyrics generated on the basis of the designated sound information series.

According to the processing as described above, the lyrics can be generated with priority given to the sound of the sound, and for example, can be used for generation of rhymed lyrics.

Furthermore, as illustrated in a lower pane of FIG. 12, the user interface according to the present embodiment may present a melody series, a sound information series, and lyrics generated by the lyrics generation unit 150 in association with each other.

According to the above presentation, the user can intuitively grasp the correspondence relationship of each piece of information, and further, can easily select the correction portion.

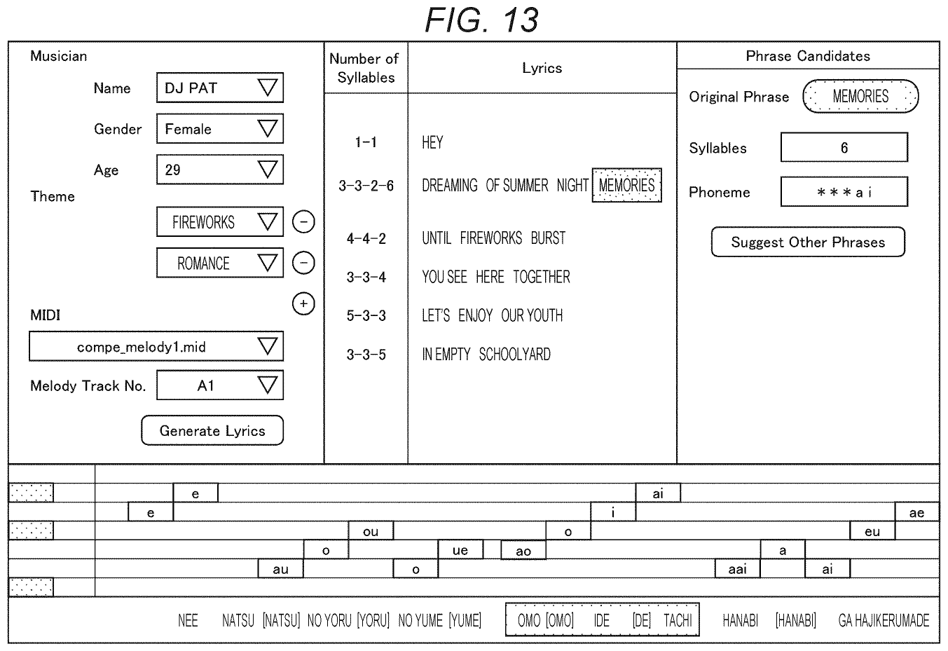

FIG. 13 is a diagram illustrating an example of a user interface related to selection of a correction portion of Japanese lyrics according to the present embodiment.

In the case of the example illustrated in FIG. 13, the user selects the phrase “memories” among the generated lyrics.

For example, the user may be able to select the correction portion by clicking an arbitrary portion in the upper center pane or the lower pane.

Further, the correction portion is selected by the user, and then information related to the selected correction portion is displayed in the upper right pane. The information includes an original phrase, the number of syllables, and a sound information series (denoted as Phoneme in the drawing) related to the correction portion.

Note that, in the above number of syllables and sound information series, information may be displayed according to the original phrase at a time when the correction portion is selected by the user, but the number of syllables and sound information series may be editable by the user.

The user edits the number of syllables and the sound information series as necessary and presses the “Suggest Other Phrases” button, and then the lyrics generation unit 150 generates an alternative candidate.

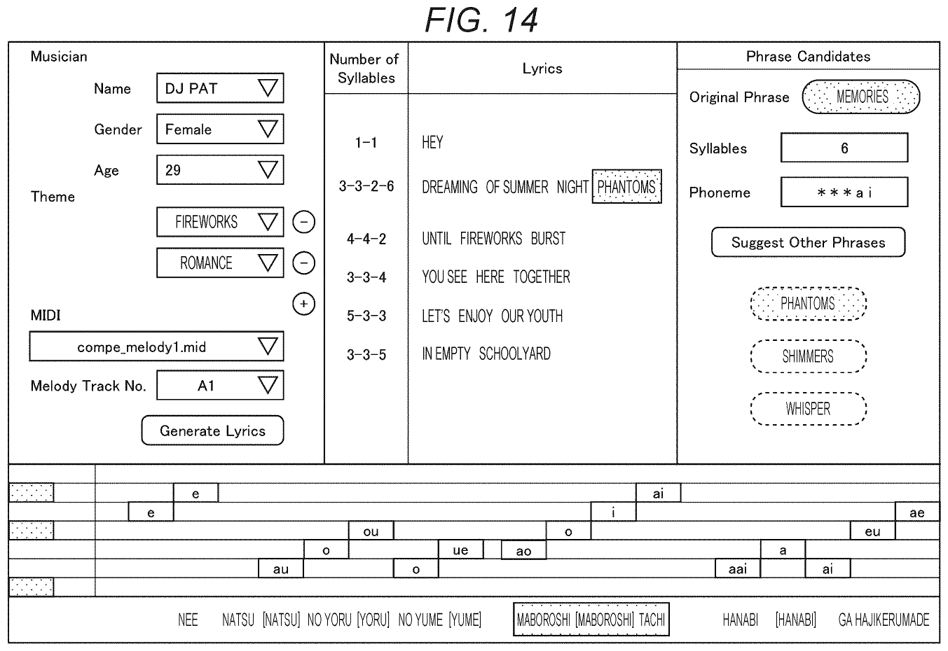

FIG. 14 is a diagram illustrating an example of a user interface related to alternative candidate presentation of Japanese lyrics according to the present embodiment.

In the case of the example illustrated in FIG. 14, a plurality of alternative candidates (“phantoms”, “shimmers”, “whisper”) generated by the lyrics generation unit 150 is displayed in the upper right pane.

The user may be able to reflect the alternative candidate in the lyrics by selecting an arbitrary alternative candidate among the plurality of displayed alternative candidates. In the case of the example illustrated in FIG. 14, the lyrics in the upper center pane and the lower pane are corrected on the basis of selection of “phantoms” by the user.

As described above, the user interface according to the present embodiment may receive designation of a phrase by the user and present an alternative candidate generated on the basis of the sound information series related to the phrase.

According to the function as described above, the user can select a phrase from more variations, and it is possible to effectively reduce the labor of correction.

Note that, in a case where there is no favorite phrase in the presented alternative candidate, the user may obtain another alternative candidate by pressing a “Suggest Other Phrases” button.

Furthermore, for example, the user may perform free input correction by double-clicking an arbitrary portion in the upper center pane or the lower pane.

The user interface example related to the generation of the Japanese lyrics according to the present embodiment has been described above. Next, a user interface example related to English lyrics generation according to the present embodiment will be described.

Note that the initial screen and the screen after reading the melody information may be the same as the Japanese lyrics and the English lyrics except for the display language, and thus illustration and detailed description thereof are omitted.

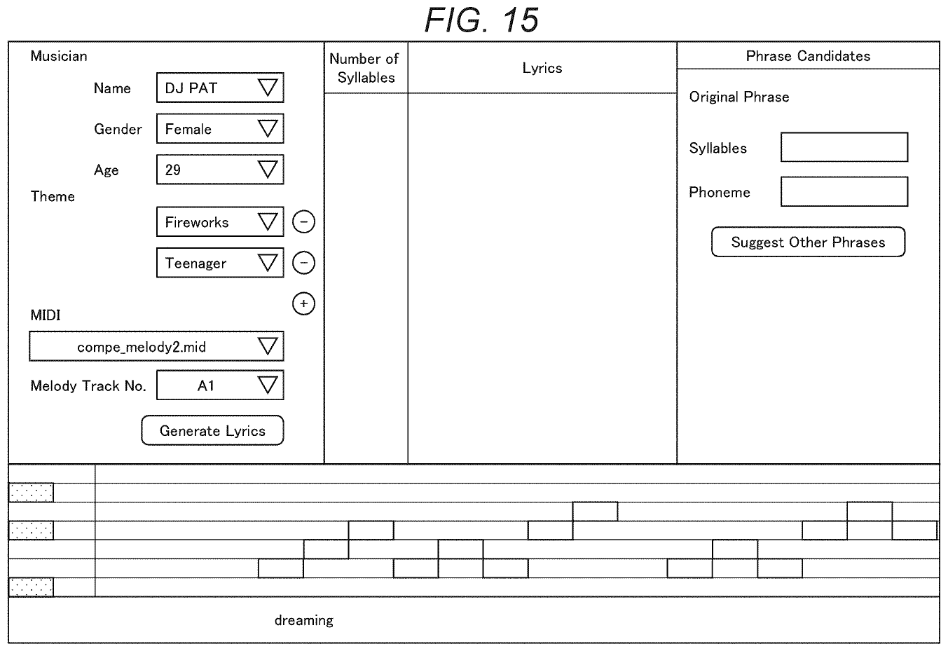

FIG. 15 is a diagram illustrating an example of a user interface related to condition input of English lyrics generation according to the present embodiment.

In the case of the example illustrated in FIG. 15, the user designates meta information in addition to melody information in the upper left pane.

Furthermore, in the case of the example illustrated in FIG. 15, the user designates (“dreaming”) the lyrics to the opening portion in the lower pane. Note that the user may also designate, for example, a part of the vowel sound series (“i:”, “I”, or the like).

The user specifies each condition as described above and further clicks the “Generate Lyrics” button in the upper left pane, and then lyrics generation by the lyrics generation unit 150 is executed.

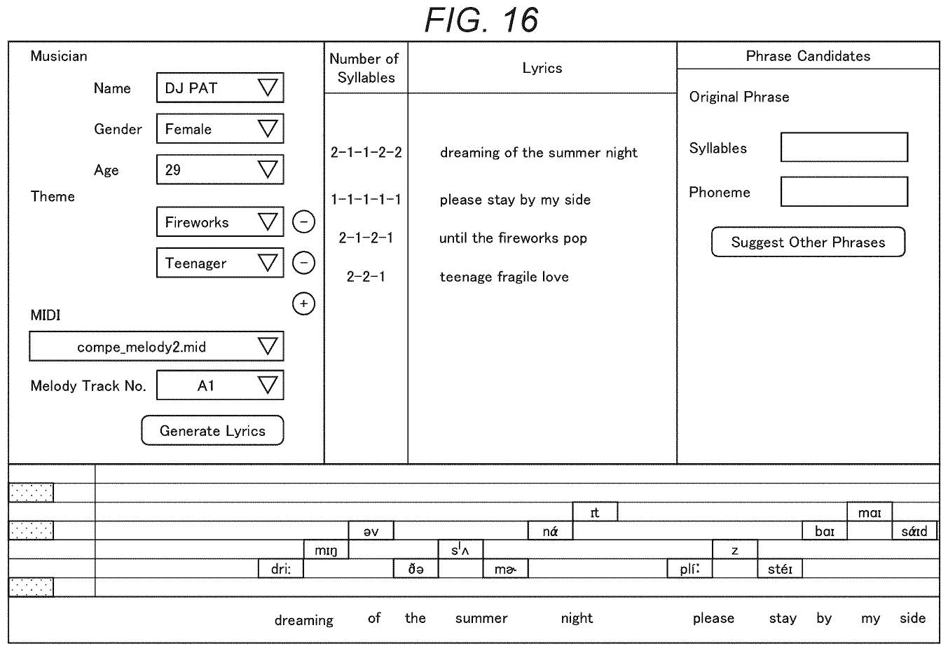

FIG. 16 is a diagram illustrating an example of a user interface after generation of English lyrics according to the present embodiment.

The upper center pane in FIG. 16 displays the lyrics generated by the lyrics generation unit 150 on the basis of the input condition (Meta data, lyrics).

Furthermore, a melody series, a sound information series, and lyrics generated by the lyrics generation unit 150 are displayed in association with each other in the pane at the center in the upper part of FIG. 16.

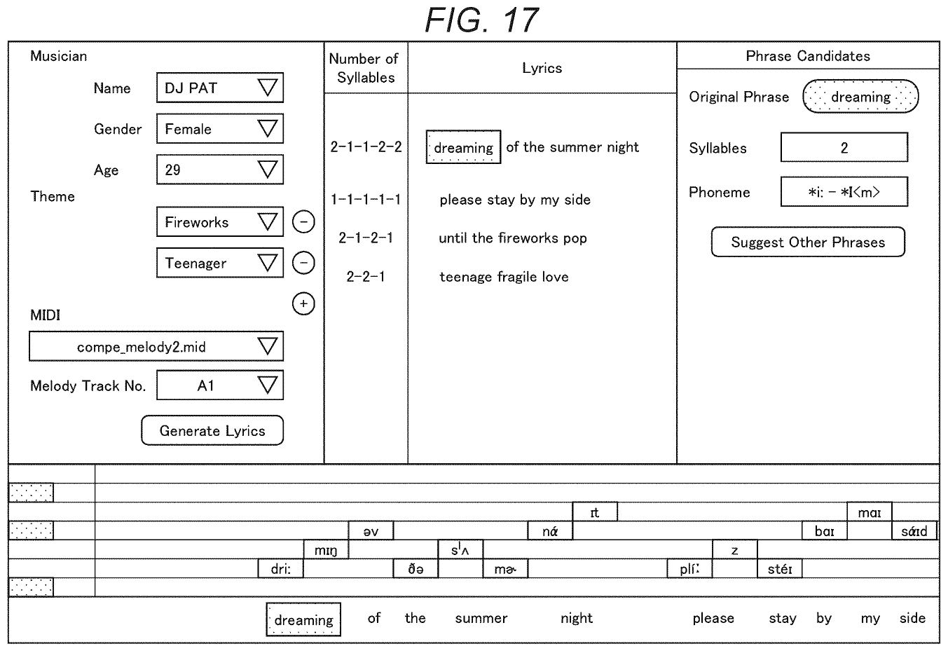

FIG. 17 is a diagram illustrating an example of a user interface related to selection of a correction portion of English lyrics according to the present embodiment.

In the case of the example illustrated in FIG. 17, the user selects the phrase “dreaming” among the generated lyrics.

Furthermore, in the upper right pane, the original phrase, the number of syllables, and the sound information series related to the selected correction portion are displayed.

The user edits the number of syllables and the sound information series as necessary and presses the “Suggest Other Phrases” button, and then the lyrics generation unit 150 generates an alternative candidate.

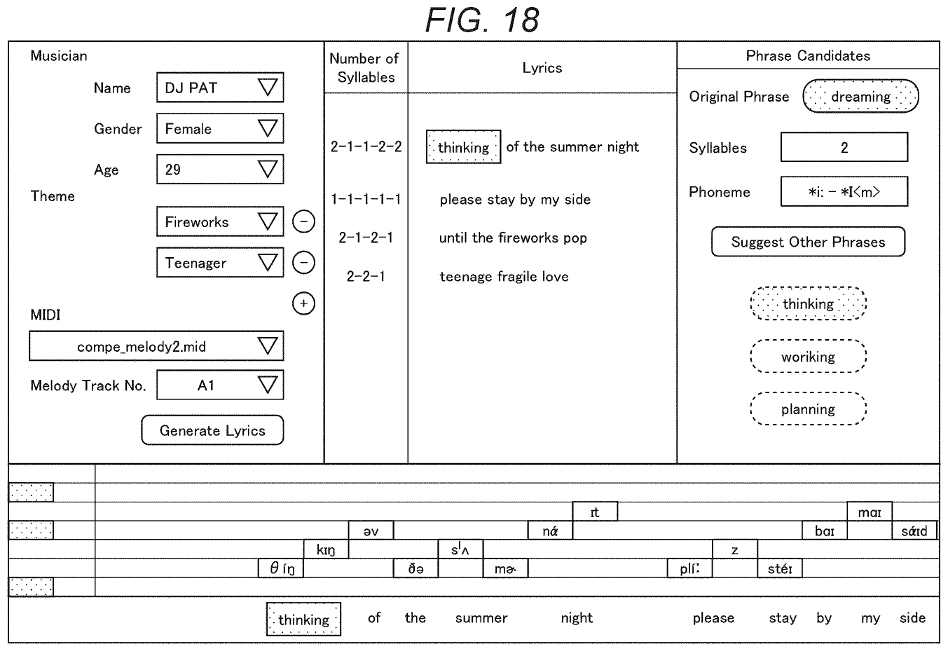

FIG. 18 is a diagram illustrating an example of a user interface related to alternative candidate presentation of English lyrics according to the present embodiment.

In the case of the example illustrated in FIG. 18, a plurality of alternative candidates (“thinking”, “working”, and “planning”) generated by the lyrics generation unit 150 is displayed in the upper right pane.

In addition, in the case of the example illustrated in FIG. 18, the lyrics in the upper center pane and the lower pane are corrected on the basis of selection of “thinking” by the user.

The user interface according to the present embodiment has been described above with reference to specific examples of the Japanese lyrics and the English lyrics.

Note that, although not illustrated due to space restrictions, various buttons for performing reproduction control (reproduction, stop, fast forward, rewind, etc.) of a melody, saving of lyrics, and the like may be arranged on the user interface according to the present embodiment.

The user interfaces illustrated in FIGS. 9 to 18 are merely examples, and the user interface according to the present embodiment can be flexibly modified.

### 2. Exemplary Hardware Configuration

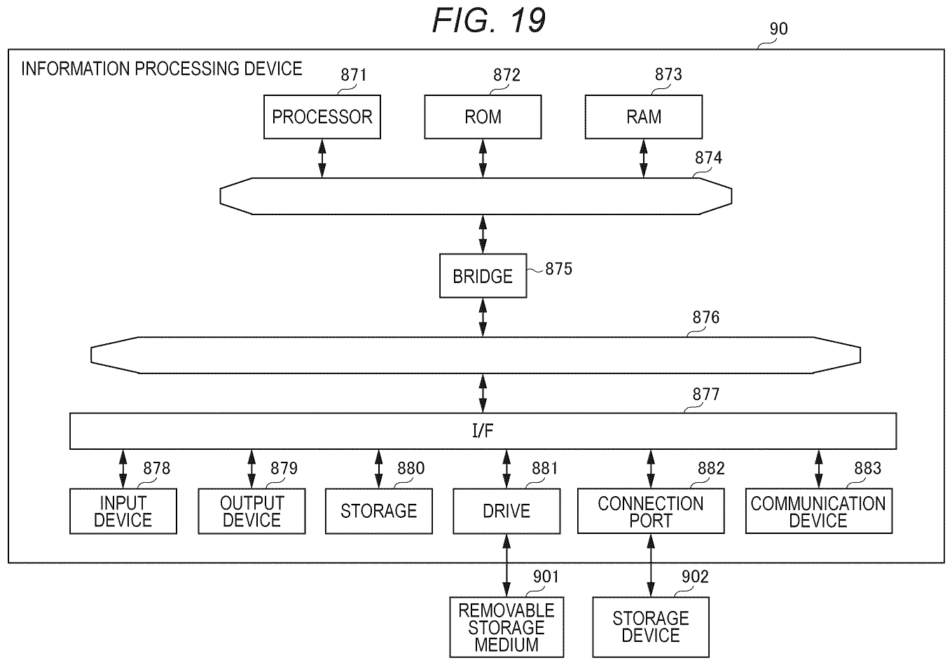

Next, a hardware configuration example of an information processing device 90 according to the embodiment of the present disclosure will be described. FIG. 19 is a block diagram illustrating an exemplary hardware configuration of an information processing device 90 according to the embodiment of the present disclosure. The information processing device 90 may be a device having a hardware configuration equivalent to that of the information processing device 10 described in the embodiment.

As illustrated in FIG. 19, the information processing device 90 includes, for example, a processor 871, a read-only memory (ROM) 872, a random access memory (RAM) 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the components may be omitted. In addition, components other than the components illustrated here may be further included.

### (Processor 871)

The processor 871 functions as, for example, an arithmetic processing device or a control device, and controls the overall operation of each component or a part thereof on the basis of various programs recorded in the ROM 872, the RAM 873, the storage 880, or a removable storage medium 901.

### (ROM 872, RAM 873)

The ROM 872 is a means for storing a program to be read into the processor 871, data to be used for calculation, and the like. The RAM 873 temporarily or permanently stores, for example, a program to be read into the processor 871, various parameters that appropriately change when the program is executed, and the like.

### (Host Bus 874, Bridge 875, External Bus 876, and Interface 877)

The processor 871, the ROM 872, and the RAM 873 are mutually connected via, for example, the host bus 874 capable of high-speed data transmission. Meanwhile, the host bus 874 is connected to the external bus 876 having a relatively low data transmission speed via the bridge 875, for example. Furthermore, the external bus 876 is connected to various components via the interface 877.

### (Input Device 878)

As the input device 878, for example, a mouse, a keyboard, a touch panel, a button, a switch, a lever, or the like is used. Moreover, as the input device 878, a remote controller (hereinafter referred to as a remote) capable of transmitting a control signal using infrared rays or other radio waves may be used. Furthermore, the input device 878 includes a voice input device such as a microphone.

### (Output Device 879)

The output device 879 is a device capable of visually or auditorily notifying the user of obtained information, such as a display device such as a cathode ray tube (CRT), a liquid crystal display (LCD), an organic electroluminescence (EL), or the like, an audio output device such as a speaker, a headphone, or the like, a printer, a mobile phone, a facsimile, or the like. Furthermore, the output device 879 according to the present disclosure includes various vibration devices capable of outputting a haptic stimulus.

### (Storage 880)

The storage 880 is a device for storing various types of data. As the storage 880, for example, a magnetic storage device such as a hard disk drive (HDD) or the like, a semiconductor storage device, an optical storage device, a magneto-optical storage device, or the like is used.

### (Drive 881)

The drive 881 is, for example, a device that reads information recorded in the removable storage medium 901 such as a magnetic disk, an optical disk, a magneto-optical disk, a semiconductor memory or the like, or writes information in the removable storage medium 901.

### (Removable Storage Medium 901)

The removable storage medium 901 is, for example, a digital versatile disc (DVD) medium, a Blu-ray (registered trademark) medium, an HD DVD medium, various semiconductor storage media, or the like. It is needless to say that the removable storage medium 901 may be, for example, an integrated circuit (IC) card on which a non-contact IC chip is mounted, an electronic device, or the like.

### (Connection Port 882)

The connection port 882 is a port for connecting an external connection device 902 such as a universal serial bus (USB) port, an IEEE 1394 port, a small computer system interface (SCSI), an RS-232C port, an optical audio terminal, or the like.

### (External Connection Device 902)

The external connection device 902 is, for example, a printer, a portable music player, a digital camera, a digital video camera, an IC recorder, or the like.

### (Communication Device 883)

The communication device 883 is a communication device for connecting to a network, and is, for example, a wired or wireless local area network (LAN), Bluetooth (registered trademark), a communication card for wireless USB (WUSB), a router for optical communication, a router for asymmetric digital subscriber line (ADSL), a modem for various types of communication, or the like.

### 3. CONCLUSION

As described above, the information processing device 10 according to an embodiment of the present disclosure includes the sound information series generation unit 140 that generates a sound information series harmonized with an input melody by using a learned model. Furthermore, the information processing device 10 according to an embodiment of the present disclosure includes the lyrics generation unit 150 that generates lyrics harmonized with a melody on the basis of the melody and the sound information series using the learned model. Further, the sound information series includes at least a vowel sound series harmonized with a melody.

According to the above configuration, it is possible to generate lyrics with more variations that are more harmonized with melodies.

While the preferred embodiment of the present disclosure has been described in detail with reference to the accompanying drawings, the technological scope of the present disclosure is not limited to such examples. It is obvious that those with ordinary skill in the technical field of the present disclosure may conceive various modifications or corrections within the scope of the technical idea described in the claims, and it is naturally understood that they also fall within the technical scope of the present disclosure.

Furthermore, individual steps related to the processes described in the present specification are not necessarily processed in time series in the order described in the flowcharts or the sequence diagrams. For example, individual steps related to the processes of individual devices may be processed in an order different from the described order, or may be processed in parallel.

Furthermore, a series of processing performed by each device described in the present specification may be implemented by a program stored in a non-transitory computer readable storage medium. For example, each program is read into the RAM when the computer executes the program, and is executed by a processor such as a CPU. The storage medium is, for example, a magnetic disk, an optical disc, a magneto-optical disk, a flash memory, or the like. Furthermore, the program may be distributed via, for example, a network without using a storage medium.

Furthermore, the effects described in the present specification are merely exemplary or illustrative, and are not restrictive. In other words, the technology according to the present disclosure may produce other effects that are apparent to those skilled in the art from the description of the present specification, in combination with or instead of the effects described above.

Note that the following configurations also fall within the technological scope of the present disclosure.

(1)

An information processing device, including:
a sound information series generation unit that generates a sound information series harmonized with an input melody by using a learned model; and
a lyrics generation unit that generates lyrics harmonizing with the melody on the basis of the melody and the sound information series by using the learned model, in which
the sound information series includes at least a vowel sound series harmonized with the melody.
   (2)

The information processing device according to the above (1), in which
the vowel sound series includes information on a type and a number of vowels or the like harmonized with the melody.
   (3)

The information processing device according to the above (1) or the above (2), in which
the sound information series further includes an accent series corresponding to the vowel sound series.
   (4)

The information processing device according to any one of the above (1) to (3), in which
the lyrics generation unit generates lyrics harmonized with the melody further on the basis of metadata specified by a user.
   (5)

The information processing device according to the above (4), in which
the metadata is additional information related to the melody or generated lyrics.
   (6)

The information processing device according to the above (4) or the above (5), in which
the lyrics generation unit generates lyrics harmonized with the melody further on the basis of constraint information related to a lyrics expression.
   (7)

The information processing device according to any one of the above (4) to (6), in which
the lyrics generation unit generates lyrics harmonized with the melody further on the basis of information related to a target of the generated lyrics.
   (8)

The information processing device according to any one of the above (1) to (7), in which
the lyrics generation unit generates lyrics harmonized with the melody further on the basis of a feature of an entire music including the melody.
   (9)

The information processing device according to any one of the above (1) to (8), in which
the lyrics generation unit generates lyrics harmonized with the melody further on the basis of the immediately preceding lyrics.
   (10)

The information processing device according to any one of the above (1) to (9), in which
the sound information series generation unit generates the sound information series harmonized with the melody further on the basis of the immediately preceding sound information series.
   (11)

The information processing device according to any one of the above (1) to (10), in which
the lyrics generation unit generates lyrics harmonized with the melody on the basis of the sound information series designated by a user.
   (12)

The information processing device according to any one of the above (1) to (11), in which
the lyrics generation unit generates an alternative candidate for a phrase selected by a user on the basis of the sound information series.
   (13)

The information processing device according to any one of the above (1) to (12), further including
a user interface control unit that receives designation of the melody by a user and controls a user interface that presents the lyrics generated by the lyrics generation unit.
   (14)

The information processing device according to the above (13), in which
the user interface receives designation of the sound information series by a user, and presents lyrics generated on the basis of the designated sound information series.
   (15)

The information processing device according to the above (13) or (14), in which
the user interface receives designation of a phrase by a user and presents an alternative candidate generated on the basis of the sound information series related to the phrase.
   (16)

The information processing device according to any one of the above (13) to (15), in which
the user interface presents the melody, the sound information series, and the lyrics generated by the lyrics generation unit in association with each other.
   (17)

An information processing method including:
by a processor,
generating a sound information series harmonized with an input melody by using a learned model; and
generating, by using the learned model, lyrics harmonized with the melody on the basis of the melody and the sound information series, in which
the sound information series includes at least a vowel sound series harmonized with the melody.
   (18)

A program for causing a computer to function as an information processing device,
the information processing device including:
a sound information series generation unit that generates a sound information series harmonized with an input melody by using a learned model; and
a lyrics generation unit that generates lyrics harmonized with the melody on the basis of the melody and the sound information series by using the learned model, in which
the sound information series includes at least a vowel sound series harmonized with the melody.

### REFERENCE SIGNS LIST

10 Information processing device
110 Operation unit
120 Metadata input unit
130 Entire melody feature extraction unit
140 Sound information series generation unit
150 lyrics generation unit
160 User interface control unit
170 Display unit
180 Storage unit

1. An information processing device, comprising:
a sound information series generation unit that generates a sound information series harmonized with an input melody by using a learned model; and
a lyrics generation unit that generates lyrics harmonizing with the melody on a basis of the melody and the sound information series by using the learned model, wherein
the sound information series includes at least a vowel sound series harmonized with the melody.

2. The information processing device according to claim 1, wherein
the vowel sound series includes information on a type and a number of vowels or the like harmonized with the melody.

3. The information processing device according to claim 1, wherein
the sound information series further includes an accent series corresponding to the vowel sound series.

4. The information processing device according to claim 1, wherein
the lyrics generation unit generates lyrics harmonized with the melody further on a basis of metadata specified by a user.

5. The information processing device according to claim 4, wherein
the metadata is additional information related to the melody or generated lyrics.

6. The information processing device according to claim 4, wherein
the lyrics generation unit generates lyrics harmonized with the melody further on a basis of constraint information related to a lyrics expression.

7. The information processing device according to claim 4, wherein
the lyrics generation unit generates lyrics harmonized with the melody further on a basis of information related to a target of the generated lyrics.

8. The information processing device according to claim 1, wherein
the lyrics generation unit generates lyrics harmonized with the melody further on a basis of a feature of an entire music including the melody.

9. The information processing device according to claim 1, wherein
the lyrics generation unit generates lyrics harmonized with the melody further on a basis of the immediately preceding lyrics.

10. The information processing device according to claim 1, wherein
the sound information series generation unit generates the sound information series harmonized with the melody further on a basis of the immediately preceding sound information series.

11. The information processing device according to claim 1, wherein
the lyrics generation unit generates lyrics harmonized with the melody on a basis of the sound information series designated by a user.

12. The information processing device according to claim 1, wherein
the lyrics generation unit generates an alternative candidate for a phrase selected by a user on a basis of the sound information series.

13. The information processing device according to claim 1, further comprising
a user interface control unit that receives designation of the melody by a user and controls a user interface that presents the lyrics generated by the lyrics generation unit.

14. The information processing device according to claim 13, wherein
the user interface receives designation of the sound information series by a user, and presents lyrics generated on a basis of the designated sound information series.

15. The information processing device according to claim 13, wherein
the user interface receives designation of a phrase by a user and presents an alternative candidate generated on a basis of the sound information series related to the phrase.

16. The information processing device according to claim 13, wherein
the user interface presents the melody, the sound information series, and the lyrics generated by the lyrics generation unit in association with each other.

17. An information processing method comprising:
by a processor,
generating a sound information series harmonized with an input melody by using a learned model; and
generating, by using the learned model, lyrics harmonized with the melody on a basis of the melody and the sound information series, wherein
the sound information series includes at least a vowel sound series harmonized with the melody.

18. A program for causing a computer to function as an information processing device,
the information processing device including:
a sound information series generation unit that generates a sound information series harmonized with an input melody by using a learned model; and
a lyrics generation unit that generates lyrics harmonized with the melody on a basis of the melody and the sound information series by using the learned model, wherein
the sound information series includes at least a vowel sound series harmonized with the melody.
